(19) United States
(12) Patent Application Publication
(10) Pub. No.: US 2026/0322919 A1
(43) Pub. Date: Oct. 15, 2026

(54) SYSTEMS AND METHODS FOR CLIENT-SIDE PROCESSING OF EMERGENCY RESPONSE DATA FOR EMERGENCY MANAGEMENT APPLICATIONS

(71) Applicant: RAPIDSOS, INC., New York, NY (US)

(72) Inventors: Patricia Ann Beesley, Cedar Grove, NJ (US); Angela Orthmeyer, Brooklyn, NY (US); Leah Lewy, Jersey City, NJ (US); James Patrick Olejar, JR., Fort Lauderdale, FL (US); Conor Fucci, Brooklyn, NY (US)

(73) Assignee: RAPIDSOS, INC., New York, NY (US)

(21) Appl. No.: 19/308,051

(22) Filed: Aug. 22, 2025

Related U.S. Application Data
(60) Provisional application No. 63/786,517, filed on Apr. 10, 2025.

(51) Int. Cl. H04M 3/51; G06F 9/451; G06F 40/30

(52) U.S. Cl. CPC H04M 3/5183; G06F 9/451; G06F 40/30; H04M 3/5116

(57) ABSTRACT

A client-side emergency data processing system may provide low-latency and/or locally generated user interface (UI) updates to facilitate emergency response management. The system may include executing an emergency management application from a web browser operating on a call-taker computing system of an ECC, global security operations center (GSOC), and/or alarm/emergency monitoring agency. The system may include transmitting, with the web browser, at least part of the incident data from the emergency management application to a client-side application. The client-side application may determine a potential intent of a user of the emergency management application and may generate emergency response insights based on the potential intent. The insights may include an emergency management suggestion, an emergency management action, or an emergency management notification. The client-side application may use a local large language model (LLM) to generate the insights. The client-side application may instruct the browser to update UI with the insights.

### CROSS-REFERENCE TO RELATED APPLICATION

This application claims the benefit of U.S. Provisional Application No. 63/786,517, filed on Apr. 10, 2025, which application is incorporated herein by reference in its entirety.

### TECHNICAL FIELD

This disclosure relates generally to emergency management systems, and in particular to providing client-side processing of emergency response data in support of emergency management application operations, including local large language model (LLM) utilization.

### BACKGROUND

In the critical moments following an emergency, rapid and accurate information dissemination is paramount for effective response. Emergency communication centers (ECCs), such as 911 call centers, serve as vital hubs for receiving initial reports and coordinating the dispatch of first responders. First responders, including firefighters, police officers, and emergency medical technicians, rely on timely and relevant information to navigate to the scene, assess the situation, and implement appropriate actions.

The ability of emergency personnel to quickly understand the nature of the emergency, the location, and any potential hazards significantly impacts response times and the safety of both the public and the responders. Traditional emergency response workflows often involve manual information gathering and dissemination, which can be time-consuming and prone to human error, particularly under the high-pressure conditions inherent in emergency situations.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIGS. 1A and 1B illustrate example diagrams of an emergency response system, in accordance with embodiments of the disclosure.

FIG. 2 illustrates an example diagram of an emergency response system operable for client-side emergency data processing, in accordance with embodiments of the disclosure.

FIG. 3 illustrates an example diagram of an emergency response system operable for client-side emergency data processing, in accordance with embodiments of the disclosure.

FIG. 4 illustrates an example diagram of an emergency response system operable for client-side emergency data processing, in accordance with embodiments of the disclosure.

FIG. 5 illustrates an example diagram of an emergency response system operable for client-side emergency data processing, in accordance with embodiments of the disclosure.

FIG. 6 illustrates an example flow diagram of a process for automating browser insights, in accordance with aspects of the disclosure.

FIG. 7 illustrates an example diagram of an application store, in accordance with aspects of the disclosure.

FIGS. 8A, 8B, and 8C illustrate example diagrams of user interfaces for an emergency management application operated at an emergency communication center (ECC), in accordance with aspects of the disclosure.

FIG. 9 illustrates an example flow diagram of processes for client-side emergency data processing, in accordance with embodiments of the disclosure.

FIG. 10 illustrates an example flow diagram of processes for client-side emergency data processing, in accordance with embodiments of the disclosure.

FIG. 11 illustrates an example diagram of a machine, in accordance with embodiments of the disclosure.

FIG. 12 illustrates an example diagram of a reduced latency architecture for an emergency response digital assistant, in accordance with embodiments of the disclosure.

### DETAILED DESCRIPTION

Various aspects of the disclosure include methods and systems for automating the display of emergency communication data in an emergency management user interface. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

A public emergency services agency may be established to provide a variety of services. A public emergency services agency can include a 911 call center, a railway network operations center (NOC), a primary call center, a secondary call center (e.g., that receives calls from or routes calls to a primary call center), and the like. A public emergency services agency may be referred to as an emergency service provider (ESP) or an emergency communications center (ECC). One type of ESP or ECC is a public safety answering point (PSAP). A PSAP is another name for a 911 call center that receives emergency calls and dispatches emergency (first) responders in response to the emergency communications (e.g., calls, text, or video messages to 911).

Telecommunicators at an ECC take on the tremendous responsibility of being the intermediary between people in need and field responders. Telecommunicators can include call-takers and dispatchers. At some ECCs a dispatcher performs both roles. A call-taker is a person who answers a 911 call, and a dispatcher communicates (e.g., via radio and/or computer-aided dispatch) the location and other details of an emergency to field responders (e.g., emergency medical technicians, police officers, firefighters, etc.). Each click and keystroke adds delay and cognitive load, so the faster the telecommunicator can access caller information (e.g., location, health data, surrounding conditions, etc.) and determine the next steps that need to be taken, the more clearly the telecommunicator can identify and dispatch the appropriate field responders.

Embodiments of the disclosure include an emergency response system that is operable to perform client-side emergency data processing to enable low-latency and/or locally generate emergency response suggestions, actions, notifications, and/or other insights. The emergency response system may include a number of client-side components that enable emergency data processing on an ECC, GSOC, or monitoring agency computing system.

The client-side components may include a web browser, a browser extension, a client-side application, and one or more local large language models (LLMs), for example. In operation, a web browser may execute an instance of an emergency management application hosted by an emergency response data system. The web browser may receive incident data (e.g., 911 call or location data). The web browser may use, for example, front end scripting languages (e.g., JavaScript) and browser extensions to provide information to a local run client-side application. The client-side application may use one or more LLMs and/or artificial intelligence (AI) agents to determine an intent of a telecommunicator and/or generate suggestions, actions, and/or notifications for manipulating a user interface (UI) of the emergency management application. As used herein, “user intent” and/or “potential intent of a user” refer to the inferred or determined purpose and desired actions of a person using an emergency management application. The disclosed methods and system may be used to keep all sensitive data on-device, satisfy CJIS/HIPAA encryption requirements by default, and operate browser-agnostically.

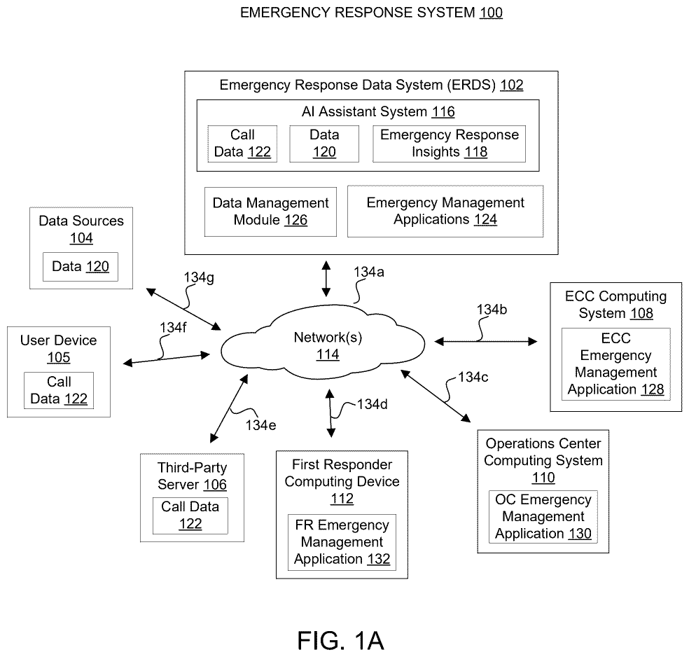

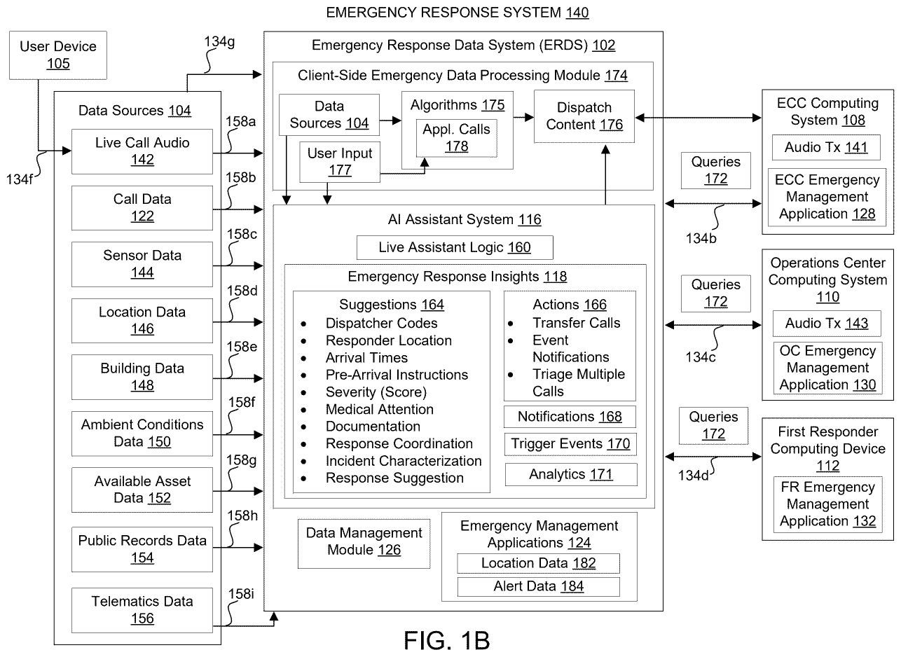

The disclosed systems and methods transform the technological area of emergency response management. For example, the disclosed emergency response system may advantageously lead to faster dispatch times, more accurate dispatch information, and faster response times, which may improve patient outcomes and potentially save more lives. Various embodiments of the disclosure are described hereafter and represented in FIGS. 1A-11.

FIGS. 1A and 1B illustrate example embodiments of an emergency response system that is configured to enhance the efficiency and effectiveness of dispatching emergency information using client-side emergency data processing, in accordance with aspects of the disclosure. FIG. 1A illustrates a diagram of an emergency response system 100 that includes an emergency response data system (ERDS) 102 that is communicatively coupled to a number of data sources 104, a user device 105, a third-party server 106, an ECC computing system 108, an operations center (OC) computing system 110, and/or a first responder computing device 112 through one or more networks 114, according to an embodiment. Networks 114 may include a number of wired networks, wireless networks, network components, and infrastructure. A number of communications channels 134 (individually, 134a, 134b, 134c, 134d, 134e, 134f, and 134g) may communicatively couple the various components of emergency response system 100.

Emergency response data system 102 includes an artificial intelligence (AI) assistant system 116 that is configured to generate emergency response insights 118 from data 120 and call data 122, according to an embodiment. AI assistant system 116 is operable to determine characteristics of call data 122 and aggregate the characteristics with data 120, according to an embodiment. AI assistant system 116 is operable to analyze the aggregated characteristics and data 120 to generate emergency response insights 118, according to an embodiment. AI assistant system 116 and/or emergency response data system 102 may then provide emergency response insights 118 to ECC computing system 108, operations center computing system 110, and/or first responder computing device 112 for receipt by emergency responders and/or emergency management personnel.

Emergency response data system 102 is configured to host and/or support a number of emergency management applications 124 that are accessed by and/or operated by ECC computing system 108, operations center computing system 110, and/or first responder computing device 112, according to embodiments of the disclosure. Emergency response data system 102 may be implemented with one or more servers that may be distributed across multiple data centers. Emergency management applications 124 may be implemented on/in emergency response data system 102 as web-based applications that are accessed via a web browser, a webhook, a persistent webhook, and/or one or more secure connections. Emergency management applications 124 may be configured to process, push, and/or receive data to/from a mobile application or an operating system (OS) specific application that is downloaded to and operated by a particular computing system or device (e.g., a first responder smart phone). Data 120 and call data 122 may be retrieved, received, managed, and directed to AI assistant system 116 and/or emergency management applications 124 with a data management module 126 to support generating and delivering emergency response insights 118.

The various computing systems that receive emergency response insights 118 are tools that may be used by emergency response personnel and emergency responders to dispatch, communicate about, and respond to incidents and emergencies that are represented by or in data 120 and/or call data 122, according to an embodiment. ECC computing system 108 represents a computing system (e.g., a terminal, a server, a personal computer, a laptop, etc.) operated at or for an ECC. ECC computing system 108 is configured to operate or provide an ECC emergency management application 128. ECC emergency management application 128 may be communicatively coupled to emergency response data system 102 to receive emergency response insights 118, data 120, and/or call data 122. ECC emergency management application 128 may be configured with a graphical user interface to visually represent emergency events and incidents (e.g., using maps, queues, icons, data cards, etc.) and to enable emergency response personnel (e.g., 911 dispatchers, telecommunicators, etc.) to dispatch and communicate emergency events.

Operations center computing system 110 represents a computing system (e.g., a terminal, a server, a personal computer, a laptop, etc.) operated at or for an operations center (e.g., a global operations security center (GSOC), a rail network operations center (NOC), etc.). Operations center computing system 110 is configured to operate or provide/execute an operations center emergency management application 130. The operations center emergency management application 130 is an instance of emergency management applications 124 that provides a graphical user interface to enable emergency response personnel (e.g., an operator, risk manager, security personnel, etc.) of corporations, other businesses, residences, academic institutions, and/or private entities to have awareness of incidents (e.g., emergency events) that occur on their particular premises or managed premises.

First responder computing device 112 is representative of computing systems, mobile devices, and/or in-vehicle devices used by emergency responders to navigate to, coordinate for, and communicate about emergency events and other incidents, according to an embodiment. The term “first responder” may be used interchangeably with the term “field responder,” as used herein. First responder emergency management application 132 may be operated on or by first responder computing device 112. First responder emergency management application 132 is communicatively coupled to emergency response data system 102 to receive emergency response insights 118, data 120, and/or call data 122 to inform the preparation and response to emergency events, according to an embodiment.

User device 105 may include a telephone, a smart phone, tablet, a laptop, personal computer, a chrome book, or other computing devices that may be used, to initiate an emergency call (e.g., a 911 call) or to otherwise report an incident, according to an embodiment. Call data 122 represents audio data, video, data, images, multimedia messages, and/or text messages provided from user device 105 to ECC computing system 108 and/or operations center computing system 110, according to an embodiment.

Third-party server 106 may include a telecommunications or device manufacturer server that receives location data, user identification data, and/or call statistics for emergency calls made by user device 105. Third-party server 106 may be configured to provide call data 122 to emergency response data system 102 to support operation of emergency applications 124, according to an embodiment. Call data 122 may include device-based hybrid (DBH) data that may be provided by some telecommunications and/or smartphone companies.

FIG. 1B illustrates an example block diagram of an emergency response system 140 that is operable to provide and/or support client-side emergency data processing, in accordance with aspects of the disclosure. Emergency response system 140 is representative of an example implementation of emergency response system 100, in accordance with aspects of the disclosure.

Data sources 104 may include one or more of a number of data types and data sources that may be used to identify, characterize, analyze or otherwise gain insights about emergency events and other incidents, according to an embodiment. Examples of data sources 104 include, but are not limited to, live call audio 142, call data 122, sensor data 144, location data 146, building data 148, ambient conditions data 150, available asset data 152, public records data 154, and/or telematics data 156, according to an embodiment. Live call audio 142 may be received by emergency response data system 102 by configuring a call audio transmitter 141 to forward/provide live call audio 142 from ECC call handling equipment (e.g., from ECC computing system 108) and/or by configuring call audio transmitter 143 to forward/provide live call audio 142 from GSOC/NOC call handling equipment (e.g., from operations center computing system 110), for example. Live call audio 142 may also include radio-based dispatches or transcripts of radio-based dispatches of emergencies from an ECC. Call data 122 may include call duration, caller name, repeat call statistics, etc. of a call to an ECC or operations center. Call data 122 may be at least partially retrieved from ECC computing systems and may include ANI (automatic number identification) data, ALI (automatic location identification) data, and/or CDR (call detail record) data. The ANI data is the phone number from which a 911 call or text to 911 originates. ALI data is the location information associated with the ANI data, and the ALI data may be retrieved from a database linked to the ANI data. CDR data is a detailed record of an incoming 911 call and may contain ANI data, the time the call came in, the time it was answered, any transfers, and the trunk number used. The position of a call-taker may also be included in the ANI data and/or the CDR data. Sensor data 144 may include, but is not limited to, data received or retrieved from residential buildings, commercial buildings, personal medical devices, personal safety devices, industrial structures, vehicles, crash detectors, smoke alarms, fire alarms, smart cameras, home security devices, moisture detectors, motion detectors, shock detectors, location sensors, gas detectors, pressure sensors, or the like, according to various embodiments of the disclosure. Location data 146 may include a location of a sensor or incident (e.g., taken from a GPS unit of a smartphone). Building data 148 may include construction materials, structure age, floorplans, renovation history, electrical schematics, HVAC layout, or the like. Ambient conditions data 150 may include weather data, weather forecasts, road conditions, wind speeds, visibility, cloud conditions, temperature, or the like. Available asset data 152 may include, but is not limited to, a number of available drones, a number of available medical devices (e.g., automated external defibrillator), a number of vehicles, a number of sprinklers in a building, or the like. Public records data 154 may include, but are not limited to, personal property records, arrest records, residential addresses, etc. Telematics data 156 may include various types of vehicle data, such as accelerometer data, gyroscope data, air bag sensors, vehicle log data, or the like. Additional miscellaneous data source or data types may include social media feeds, new feeds, geofence data, traffic feeds, visual impairment status, auditory impairment status, or the like. The various data sources 104 may be communicatively coupled to emergency response data system 102 through a number of communications channels 158 (individually, 158a, 158b, 158c, 158d, 158e, 158f, 158g, 158h, and 158i), according to embodiments of the disclosure.

AI assistant system 116 may include a number of components to support generating emergency response insights 118 for display by one or more of ECC emergency management application 128, operations center emergency management application 130, and/or first responder emergency management application 132, according to an embodiment. AI assistant system 116 may include live assistant logic 160, which may include aspects of a retrieval, augmentation, generation (RAG) system, to generate emergency response insights 118 based on call data 122, data sources 104, and/or trigger events 170, in accordance with aspects of the disclosure.

Emergency response insights 118 may include suggestions 164, actions 166, and/or notifications 168 that are generated in response to one or more trigger events 170, according to an embodiment. Emergency response insights 118 may also include analytics 171 that represent emergency communications statistics handled by an ECC, an operations center, and/or a first responder computing device at a particular location, for a region, and/or for a state or country. Emergency response insights 118 may also include inferences (e.g., potential cause of an accident, potential health/mental/physical characteristics of an accident victim, etc.) about an emergency communication that may be derived based on LLM training and/or information contained within one or more data sources 104. Suggestions 164 may be displayed or transmitted to emergency applications 124 to provide summaries, suggested actions, additional awareness, or other insights to a dispatcher, telecommunicator, emergency management operator, or first responder, according to an embodiment. Suggestions 164 may include, but are not limited to, 911 dispatcher codes, responder location, arrival times, pre-arrival instructions for first responders, severity of an incident (e.g., a severity score), live updates to incidents (based on live audio analysis and/or sensor data), medical procedures, documentation (e.g., standard operating procedures), response coordination, incident, characterization, and/or response suggestions, in accordance with various embodiments of the disclosure. Suggestions 164 may also include AI generated search terms and/or search phrases that are based on historical context of a particular user, spatial context, and/or temporal context, for example. Suggestions 164 may also include suggested actions, such as show traffic layer, dispatch to a particular location, display video feed layer, provide estimated time of arrival (ETA) of first responders, or other selectable actions. Emergency response data system 102 may cause one or more suggestions 164 to be displayed on a user interface of ECC emergency management application 128, operations center emergency management application 130, and/or first responder emergency management application 132, according to various embodiments of the disclosure.

Actions 166 are examples of actions that AI assistant system 116 may, in coordination with emergency response data system 102, initiate to facilitate a response to an emergency event. Actions 166 may be at least partially performed on the client-side based on client-side emergency data processing that is at least partially supported by client-side resources, such as client-side local LLMs. Actions 166 may include, but are not limited to, transfer calls (e.g., to an ECC having jurisdictional authority for a call), triage multiple calls (e.g., group, associate, combine, or summarize), call a point of contact (e.g., at a business location of an incident), cluster a group of calls or communications that are related to the same incident, automatedly respond to duplicate calls/texts about an emergency, search for a phone number of a point of contact, communicate with air ambulance server to dispatch an air ambulance, dispatch field responders to a location, display and/or populate dispatch protocols, and/or generate a group chat or a group video conference between people who are located near or who are responding to a particular incident, according to various implementations of the disclosure. Actions 166 may also include actions to manipulate and/or navigate the UI of an ECC or GSOC emergency management application. For example, actions 166 may include enabling and displaying a particular layer, transmitting a digital request for resources (e.g., dispatching an air ambulance), requesting resources from an adjacent or nearby ECC, and/or sending emergency information to a computer aided dispatch (CAD) system.

Notifications 168 may include informational content or alerts derived from a combination of the trigger events 170, live call audio 142, or other data sources 104, in accordance with aspects of the disclosure. Notifications 168 may include displaying particular insights about one or more related incidents, information about changes to an incident (e.g., a change of location, nature of a fire, number of victims, etc.), available asset updates, or the like.

Trigger events 170 include events that may serve to initiate the aggregation of data sources 104, analysis of data sources 104, and/or the generation of emergency response insights 118, according to an embodiment. Examples of trigger events 170 may include, but are not limited to, a 911 call, a call to a rail NOC, a call to a GSOC, a text message to 911, a text message to a rail NOC, initiating a videoconference with 911, an activated alarm, a change in sensor data, a change in ambient condition data 150 (e.g., an abnormal increase or decrease in temperature or moisture in a space), detection of a vehicle accident, airbag deployment, receipt of a query 172 from ECC computing system 108, receipt of a query 172 from an operations center computing system 110, and/or receipt of a query from first responder computing device 112, according to embodiments of the disclosure. Trigger events 170 may also include telematics data associated with a vehicular accident or incident.

Analytics 171 include various metrics for communications occurring at an ECC, a region of ECCs, a state of ECCs, one or more operations centers, and/or one or more other first responder devices or stations, in accordance with aspects of the disclosure. The metrics can cover areas such as call handling, resource management, and overall operational efficiency. The metrics may also include call answer times, abandonment rates, average handling time, and call volume trends to ensure service levels are being met and identify potential bottlenecks in the system. The metrics may also include incident response times and resource allocation to gauge the efficiency of emergency response coordination. As disclosed herein, AI assistant system 116 may include one or more AI agents that may be configured to generate visualizations (e.g., charts, graphs, etc.) based on underlying context data, natural language questions, historical datasets, and/or forecasts.

Live assistant logic 160 includes instructions, scripts, and/or one or more processes that support operations of AI assistant system 116, according to an embodiment. For example, live assistant logic 160 may be configured to communicate with data management module 126 to receive data for processing. Live assistant logic 160 may be configured to provide generated emergency response insights 118 to emergency management applications 124, for example. Live assistant logic 160 may include or provide various application programming interfaces (API) to facilitate receipt of query 172, according to an embodiment. Live assistant logic 160 may include decision trees, flow diagrams, instructions, one or more AI agents, one or more large language models (LLMs), or other processes to support live (real-time) interactions with human operators (e.g., call-taker, dispatcher, telecommunicator, operations center operator, first responder, etc.), according to an embodiment.

Live assistant logic 160 may be implemented using one or more of a variety of technologies. Live assistant logic 160 may be a service that emergency response data system 102 communicates with remotely or may include a number of libraries and software packages installed onto one or more local or distributed server (e.g., cloud) systems. Live assistant logic 160 may be at least partially distributed to a client-side emergency data processing system using, for example, a browser extension, a client-side application, a local LLM, a client-side operating system-based LLM, and/or a client-side networked LLM. Live assistant logic 160 may be implemented using transfer learning models that apply knowledge learned from one task to another, typically using pre-trained models. Examples of transfer learning models that may be used include, but are not limited to, BERT (bidirectional encoder representations from transformers): a transformer-based model for natural language processing tasks; GPT (generative pretrained transformer): a generative model for text-based tasks; and ResNet: a pre-trained deep learning model commonly used for image classification. Live assistant logic 160 may incorporate other types of models, such as deep learning models, unsupervised models, generative models, recommender systems, or the like. Examples of deep learning models may include convolutional neural networks (CNN), which may be used for image recognition tasks; recurrent neural networks (RNN), which may be used for sequential data, such as time series or natural language; and long short-term memory networks (LSTMN), for example.

Live assistant logic 160 may be implemented using one or more large language models (LLMs), according to an embodiment. LLMs are AI models that are trained to understand and generate human language. LLMs use large amounts of text data to learn patterns, context, and meaning in language. Examples of LLMs include, but are not limited to, generative pretrained transformers (GPTs), BERT, DistilBERT, T5 (Text-to-Text Transfer Transformer), XLNet, Turing-NLG, LLaMA (Large Language Model Meta AI), Claude, PaLM (Pathways Language Model), Megatron-Turing NLG, ChatGPT, OpenAI Codex, ERNIE (Enhanced Representation through Knowledge Integration), and/or Grok. In one embodiment, an LLM is trained on historical emergency response data (e.g., 911 call audio, emergency call audio, non-emergency call audio, sensor data, traffic data, weather data, field responder locations, telematics data, public records data, etc.), is operable to support ERDS 102 operations, and is offered for download as a local LLM to ECC computing system 108 and/or operations center computing system 110.

Live assistant logic 160 or other portions of AI assistant system 116 may be at least partially implemented on a computing system that is local to the ECC to reduce latency in data transmission between an ECC and remote data processing servers. For example, live assistant logic 160 and/or a RAG system may be implemented using a local LLM, allowing live call audio and historical ECC data to be received from call handling equipment, processed on-premises, and re-inserted into the call handling equipment or to an ECC terminal. In accordance with various embodiments of the disclosure, a local implementation of live assistant logic 160 may include installation in an edge device coupled to an ECC or GSOC network, installation of a local LLM, installation of a local application, and/or local installation of a browser extension that communicates with the local application and local LLM, for example.

Emergency management applications 124 may provide location data 182 and alert data 184, in addition to emergency response insights 118, according to an embodiment. Location data 182 may include a device-based hybrid (DBH) location of an emergency event. The device-based hybrid location may be derived from call data 122 and/or may be received from third-party server 106. The device-based hybrid location may be based on GPS location of user device 105 or based on registered locations of electronic devices in the vicinity of and communicatively coupled to user device 105, according to various embodiments. Alert data 184 may include alerts or notifications that are based on sensor data 144 and/or one or more additional data sources 104, according to an embodiment. Location data 182 and/or alert data 184 may be provided to and/or displayed by one or more of the emergency management applications 128, 130, and/or 132, according to various embodiments.

Emergency response data system 102 and AI assistant system 116 may be configured to be responsive to queries 172 that may be entered into and received (from users) through any one of emergency management applications 128, 130, and/or 132. Emergency response data system 102 and AI assistant system 116 are configured to be responsive to queries 172 in the absence of a call-based trigger and/or a data-based trigger, according to an embodiment. Emergency management applications 128, 130, and/or 132 may include a query input text box, may perform audio to text, or may receive and transmit audio to provide queries 172 to AI assistant system 116. AI assistant system 116 may use queries 172 as a trigger event 170. AI assistant system 116 may convert queries 172 into a semantic vector to perform a vector search of a vector database, a content search of a vector database, and/or a hybrid vector-content search of a vector database. Queries 172 may include queries related to summaries, graphs, charts, or other visualizations of analytics for an ECC, operations center, and/or first responder device/station, according to an embodiment. AI assistant system 116 may provide responses to queries 172 as emergency response insights 118 and using similar UI elements in graphical user interfaces of emergency management applications 128, 130, and/or 132.

ERDS 102 includes a client-side emergency data processing module 174 that is operable to support providing client-side, low-latency, and/or locally generated emergency response insights, in accordance with aspects of the disclosure. In other words, client-side emergency data processing module 174 may be configured for client-side processing of emergency response data to support client-sided operations of an emergency management application, for example. The client-sided operations with emergency response insights may include analyzing emergency response data locally (on the client) displaying suggestions in a browser, automatedly performing actions from a browser, and/or displaying notifications/analytics to the browser, for example. Client-side emergency data processing module 174 may provide emergency response insights by embedding application calls 178 (e.g., JavaScript calls to client-side applications, WebAssembly (Wasm), TypeScript, etc.) into emergency applications 124 to leverage resources (e.g., local LLMs, locally networked LLMs, local/native applications, etc.) of ECC computing system 108 and/or operations center computing system 110 with emergency management applications 124, to provide low-latency and/or locally generated emergency response insights, in accordance with aspects of the disclosure. Client-side emergency data processing module 174 includes one or more algorithms 175 that generate application calls 178 and/or dispatch content 176 based on one or more of data sources 104 and/or based on user input 177, according to an embodiment. Client-side emergency data processing module 174 may also be operable to enable operations of AI assistant system 116 using (e.g., predominantly) client-side resources to generate or contribute to dispatch content 176 and/or emergency response insights 118, in accordance with aspects of the disclosure.

Algorithms 175 may include decision trees, processes, methods, LLMs, and/or AI systems to generate dispatch content 176. Algorithms 175 may include code that initiates client-side processing of data by, for example, sending emergency data to one or more local LLMs and/or AI agent networks. Algorithms 175 may be configured to cause the display one or more data cards having caller information. The caller information that is displayed may be automatically displayed for a particular phone number that a call-taker answers to respond to a 911 call. The caller information may include information such as location data 146 that is representative of a location of a 911 call or a text to 911, which may be received from a third-party server 106 (e.g., a telecommunications server), in accordance with aspects of the disclosure. The caller information may also include health information, name, weather information, caller history, first responder ETA, special standard operating procedures/instructions, or additional insights inferred from data sources 104, for example. Upon receipt of additional data sources 104 and/or user input 177, algorithms 175 may be configured to generate dispatch content 176 (e.g., application calls 178, data cards, particular workflows, display of emergency response insights 118, etc.) that may be transmitted to and/or displayed by ECC emergency management application 128 and/or operations center emergency management application 130, in accordance with various aspects of the disclosure. Various client-side components may be configured to interact with emergency management applications 124 at the client using, for example, browser extensions, local applications, local LLMs, OS-based LLMs, and/or locally networked LLMs, according to embodiments.

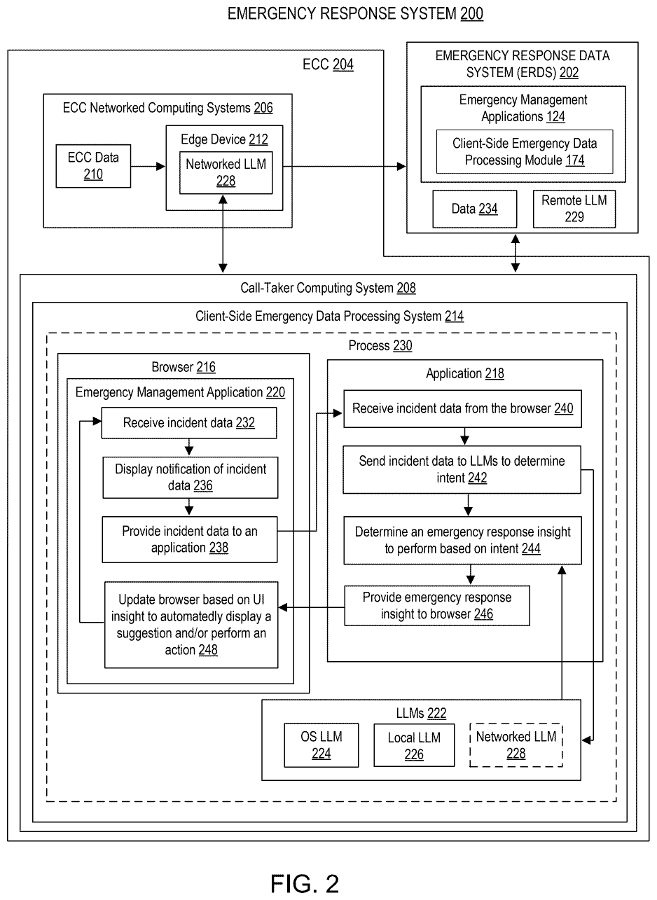

FIG. 2 illustrates a diagram of an emergency response system 200 that is operable to provide client-side emergency data processing to provide client-side, browser-automated, low-latency, and/or locally generated emergency response insights, in accordance with aspects of the disclosure. Emergency response system 200 is an example implementation of emergency response systems 100 and 140. Emergency response system 200 may include ERDS 202 that is communicatively coupled to an ECC 204 to provide emergency management applications with emergency response insights and to facilitate response to emergency incidents, according to an embodiment. ECC 204 includes ECC network computing systems 206 that distribute ECC data 210. ECC data 210 may be received and selectively distributed to ERDS 202 with an edge device 212 that is (locally) communicatively coupled to ECC networking computing systems 206, according to an embodiment. ECC data 210 includes, but is not limited to, ANI data, ALI data, CDR data, SIP data, and/or CAD data, as examples. In response to receiving a 911 call at ECC 204, ECC network computing systems 206 may selectively provide ECC data 210 to call-taker computing system 208, call-taker telephones, and/or displays, for example. Call-taker computing system 208 includes client-side emergency data processing system 214 that is operable to communicate with ERDS 202 to provide client-side, low-latency, and/or locally generated urgency response insights, in accordance with aspects of the disclosure.

Client-side emergency data processing system 214 is operable to process emergency response data and update a user interface of a browser with emergency response insights, according to an embodiment. Client-side emergency data processing system 214 may include a browser 216, an application 218, and LLMs 222. Browser 216 is operable to execute an instance of emergency management applications 124 as an emergency management application 220. Application 218 is operable by call-taker computing system 208 and is communicatively coupled to receive and/or provide information to/from browser 216. LLMs 222 include varieties of LLMs that may be operated by and/or accessible to call-taker computing system 208. Browser 216, application 218, and LLMs 222 operate together to perform a process 230 of client-side processing of emergency response data, in accordance with aspects of the disclosure.

Process 230 includes a number of operations that may be at least partially performed by call-taker computing system 208, according to an embodiment. One or more of the operations may be performed in parallel and/or in an order that differs from the diagram of FIG. 2.

At operation 232, process 230 receives incident data (e.g., ECC data 210 and/or data 234), according to an embodiment. Data 234 represents data that may be received from one or more data sources 104 (shown in FIGS. 1A and 1B).

At operation 236, process 230 displays a notification of incident data in browser 216, according to an embodiment. The notification may include displaying caller information (e.g., a telephone number) in a queue of incidents to facilitate selection and viewing of the incident data.

At operation 238, process 230 provides the incident data to application 218, according to an embodiment. The incident data may be provided to application 218 by executing one or more client-side and/or browser-based instructions, which may be provided to the browser through emergency management application 220. Using a browser extension, API, and/or messages, browser 216 may be configured to communicate with application 218 and/or initiate the execution of application 218 by call-taker computing system 208.

At operation 240, process 230 receives incident data from browser 216, according to an embodiment.

At operation 242, process 230 sends incident data to LLMs 222 (e.g., OS-based LLM 224, local LLM 226, networked LLM 228) to determine intent of a user/call-taker using emergency management application 220, according to an embodiment. The intent may include the intent of the user responding to receipt of the incident data and/or the intent of the user engaged in a telephone call with a 911 caller. LLMs 22 may be provided a list of potential intent options to choose from based on call audio, call transcripts, caller location, a telephone number, sensor data, weather data, traffic data, social media posts, current events, the day of the week, the day of the year, and/or field responder locations or availability, for example.

At operation 244, process 230 determines an emergency response insight to perform based on the determined intent, according to an embodiment. Application 218 may store a number of predetermined response insights from which application 218 selects, based on the determined call-taker intent, according to an embodiment. In one embodiment, application 218 includes logic to at least partially determine call-taker intent and omits use of LLMs 222.

At operation 246, process 230 provides emergency response insights to browser 216 (e.g., using API, browser extension messages, etc.), according to an embodiment.

At operation 248, process 230 includes updating browser 216 based on the emergency response insight to automatically display a suggestion, perform an action (e.g., turn on/off a map layer), and/or display a notification, according to an embodiment. Process 230 may return to operation 232 upon receipt of subsequent incident data, for example.

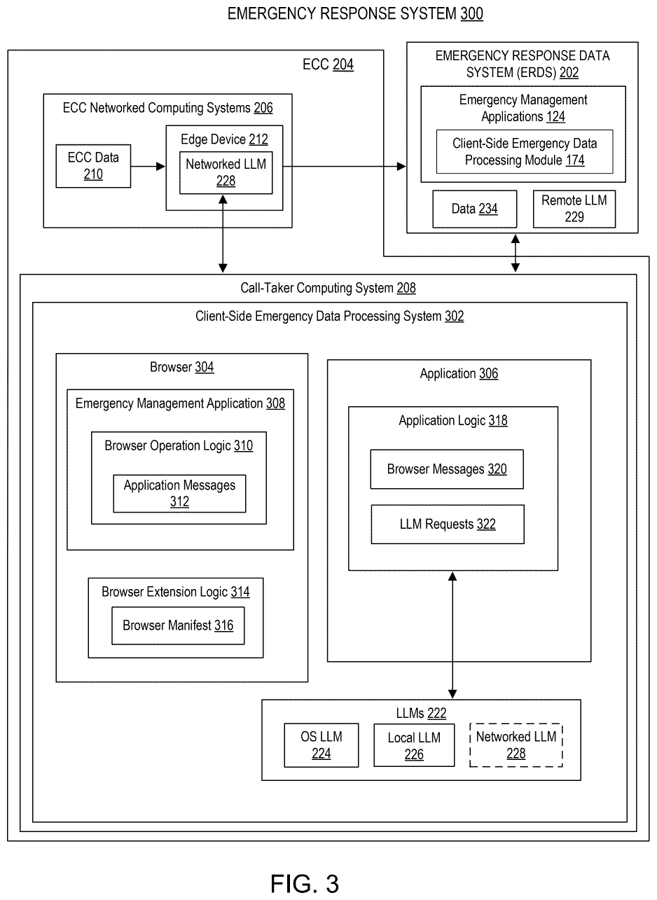

FIG. 3 illustrates a diagram of an emergency response system 300 operable to perform client-side emergency data processing, in accordance with aspects of the disclosure. Emergency response system 300 is an example implementation of emergency response system 100, emergency response system 140, and/or emergency response system 200, in accordance with aspects of the disclosure. The features and/or components of emergency response system 300 may be combined with any of the components of any other embodiments of an emergency response system disclosed herein. Emergency response system 300 includes a client-side emergency data processing system 302 having components that enable client-side, low-latency, and/or locally generated emergency response insights, in accordance with aspects of the disclosure. One or more of the components of client-side emergency data processing system 302 may support the various operations of process 230 (shown in FIG. 2), according to an embodiment. Client-side emergency data processing system 302 includes browser 304 communicatively coupled to an application 306 that is communicatively coupled to LLMs 222, for example.

Browser 304 is operable to execute an instance of an emergency management application 308, which may be an example instance of emergency management applications 124. Emergency management application 308 and/or browser 304 may include browser operation logic 310 that delivers application messages 312 to application 306 and that receives browser messages 320 from application 306. Application messages 312 include, but are not limited to, ECC data 210, data 234, and/or instructions to execute application 306, according to an embodiment. Application messages 312 and/or browser operation logic 310 may include JavaScript and/or other client-side executable instructions that are provided by or defined by ERDS 202, according to an embodiment.

Browser 304 includes browser extension logic 314 operable to enable communication between browser 304 and application 306. Browser extension logic 314 is representative of a browser extension that may be downloaded (e.g., from an online storefront) and that may be operable to configure permissions and other characteristics of browser 304. Browser extension logic 314 may include a browser manifest 316 that defines local file and application access (e.g., nativeMessaging permissions) to call-taker computing system 208. Browser manifest 316 may include a local/absolute path to application 306, a description of application 306, an identifier of application 306, and/or a list of extensions that are permitted to connect to application 306 (e.g., with application 306 is configured as a native messaging host).

Application 306 is an example implementation of application 218, according to an embodiment. Application 306 is a native messaging host, according to an embodiment. Application 306 is a native messaging host that is implemented as an executable file as a Python script, a shell script, or an otherwise compiled executable file that is compatible with the operating system of call-taker computing system 208, for example. Application 306 may include application logic 318 that are instructions for operations performed by application 306. Application logic 318 may include browser messages 320 and LLM requests 322, for example. Browser messages 320 include instructions and/or information to be provided back to browser operation logic 310 to cause browser 304 to display suggestions, perform actions (e.g., dispatch emergency resources), and/or provide locations, according to an embodiment. LLM requests 322 represent prompts, instructions, LLM identifiers, that may be used to provide instructions/prompts to LLMs 222 to at least partially define browser messages 320, according to an embodiment.

To communicate information/instructions to application 306, browser extension logic 314 may perform a number of operations. For example, browser extension logic 314 may call a Native Messaging API function (e.g., connectNative(host_name)) to establish a persistent connection, which may launch the native host process for application 306 if not already running. Browser extension logic 314 may then send messages to the native host process for application 306 using, for example, sendNativeMessage call. Browser 304 may verify that browser extension logic 314 has adequate permissions (e.g., nativeMessaging permissions) and then may pass the browser extension messages to the native host (e.g., application 306 and/or call-taker computing system 208). Once the native host (e.g., application 306) is running, browser 304 and the native host may communicate by exchanging JSON messages via stdin and stdout calls. The native host may read messages from stdin, process the message, perform requested actions, and write a response (e.g., browser messages 320) using stdout.

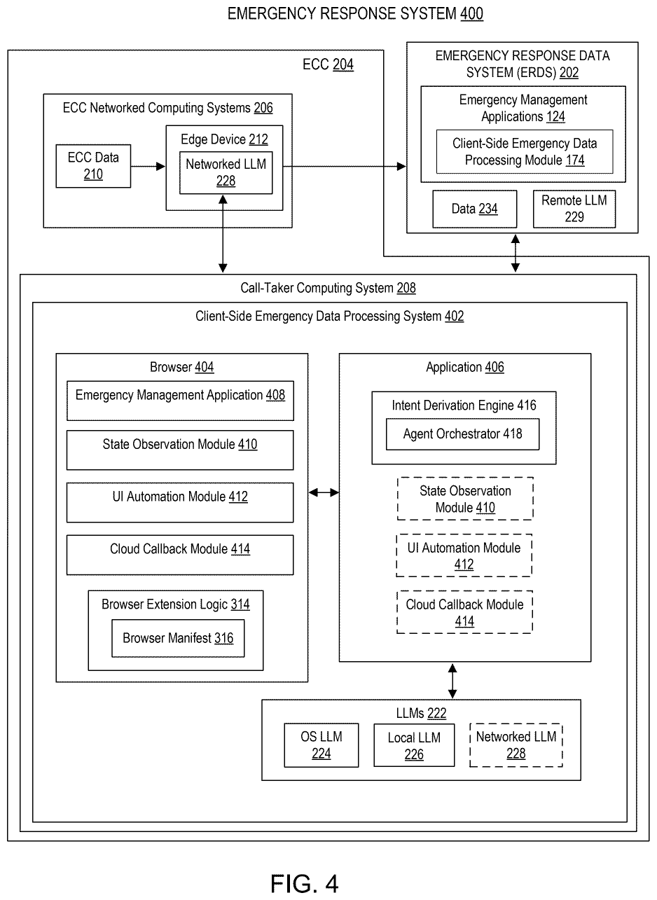

FIG. 4 illustrates a diagram of an emergency response system 400 operable to provide client-side emergency data processing, in accordance with aspects of the disclosure. The framework of emergency response system 400 may maintain all sensitive data on-device, may be configured to satisfy CJIS/HIPAA encryption requirements by default, and may operate browser-agnostically (e.g., enabling use of Chrome, Edge, Firefox, etc.). Emergency response system 400 is an example implementation of one or more of emergency response systems 100, 140, 200, 300, according to an embodiment. Emergency response system 400 includes a client-side emergency data processing system 402, according to an embodiment.

Client-side emergency data processing system 402 includes a browser 404 communicatively coupled to an application 406, according to an embodiment. Browser 404 is an example implementation of one or more of browsers 216 and/or 304, according to an embodiment. Application 406 is an example implementation of a native messaging host and of applications 218 and/or 306, according to an embodiment. Browser 404 may include a number of components that may be operated by browser 404 and/or emergency management application 408. Emergency management application 408 is an example instance of emergency management applications 124, according to an embodiment.

Browser 404 may be operable to store and/or execute a state observation module 410, a UI automation module 412, and/or a cloud callback module 414, according to an embodiment. The software modules of browser 404 are alternatively or partially stored and/or executed by application 406, according to an embodiment. The modules are executed by browser extension 314 and/or application 408, in accordance with some implementations.

State observation module 410 may be implemented as a portion of browser or browser extension logic that is operable to subscribes to a front-end state store (e.g., Redux, Zustand, etc.) and emits structured “state deltas”, according to an embodiment. State observation module 410 may be implemented as JavaScript libraries for managing application data and for inspecting, debugging, and understanding how that data changes over time. State observation module 410 may be configured with instructions to provide inspection of the state of data or the state of emergency management application 408. State observation module 410 may be configured with instructions to provide logging of actions performed by or within emergency management application 408. State observation module 410 may be configured with instructions to provide changes between the states of emergency management application 408, for example.

State observation module 410 performs state observations by using a global store to house dynamically sourced content gathered from APIs, Websockets, and similar sources, according to an embodiment. A JavaScript listener may be registered and used to subscribe to the global store to access newly sourced data and/or state changes. Example functions that may be used to register or subscribe to a store may include “store.subscribe(fn)” and/or “useStore.subscribe(fn)”, for example.

UI automation module 412 may be implemented as a portion of browser or browser extension logic that is operable to safely manipulates the UI, perform dispatch actions, or call extension APIs to carry out the micro-agent commands under configurable confidence thresholds, according to an embodiment.

Cloud callback module 414 may be implemented as a portion of browser or browser extension logic that is operable to perform non-sensitive, asynchronous enrichments with remote LLM 229 while keeping core inference local to call-taker computing system 208, according to an embodiment.

Application 406 may include an intent derivation engine 416 that is operable to determine an intent of the user of call-taker computing system 208 while utilizing one or more of LLMs 222, according to an embodiment. Intent derivation engine 416 may be operable to process/store rule sets and/or interface with (local) LLMs 222 to execute locally and to map state deltas (of emergency management application 408) to high-level intents. A table, data structure, or other logic may be used to map each of a number of state deltas to corresponding ones of a number of high-level intents of a user. In response to feedback or insights from LLMs 222, intent derivation engine 416 may return structured content (e.g., JSON) with an intent and parameters. As an illustrative example, intent derivation engine 416 may return something like {“intent”: “LOAD_SOP”, “parameters”: {“sopId”: “Fire_Response_v2”}}, which may cause UI automation module 412 to display relevant portions of SOPs related to fire response, for example. In the illustrative example, the intent may be picked up from changes to an incident queue or an alerts queue, which (in this example) may result in operations to load an SOP that supports the user's browser experience regarding “Fire Response.”

Intent derivation engine 416 may include an agent orchestrator 418, which may be operable to manage data flow to/from LLMs 222, according to an embodiment. Intent derivation engine 416 may be operable to route each high-level intent to one or more micro-agents (or a single monolithic agent) that may be specialized for specific tasks, such as autofill, unit recommendation, SOP surfacing, summarization, correlation, anticipation of the next action from a user.

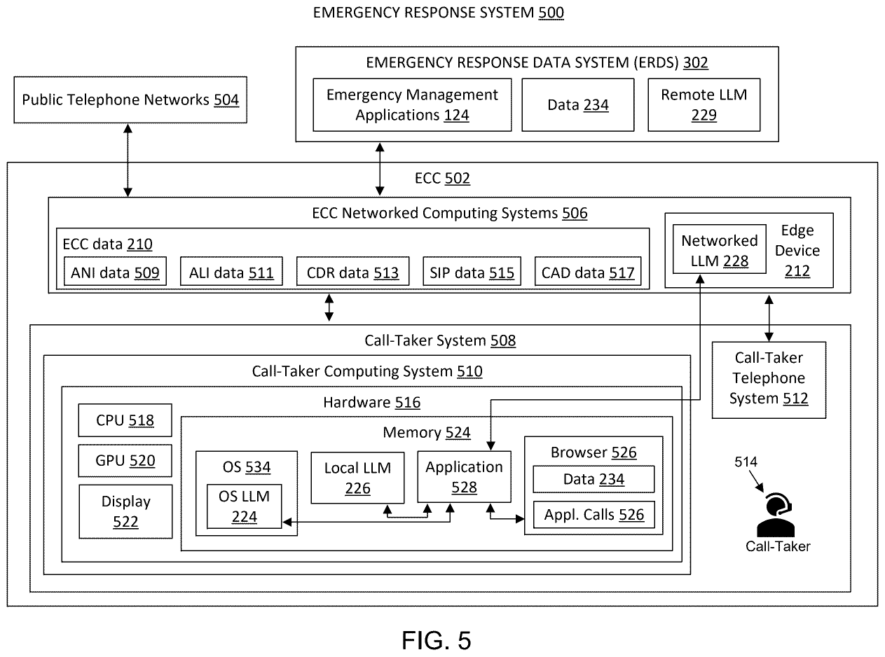

FIG. 5 illustrates a diagram of an emergency response system 500 that illustrates a distribution of components of a client-side emergency data processing system, in accordance with aspects of the disclosure. As disclosed in other embodiments, client-side emergency data processing system may include browser components, a client-side application, and one or more LLMs stored locally or otherwise accessible by a client (e.g., a call-taker computing system). Emergency response system 500 includes an ECC 502 communicatively coupled to public telephone networks 504 to receive ECC data 210. ECC 502 includes ECC network computing systems 506 communicatively coupled to a call-taker system 508 to support client-side emergency data processing, according to an embodiment. ECC data 210 may include, but is not limited to, ANI data 509, ALI data 511, CDR data 513, SIP data 515, and/or CAD data 517.

Call-taker system 508 includes a call-taker computing system 510 and a call-taker telephone system 512 coupled to ECC network computing systems 506 and operable to provide client-side emergency data processing for a call-taker 514. Although a single call-taker system 508 is illustrated, it is to be understood that ECC 502 may have multiple call-taker systems associated with each of a number of call-takers, for example.

Call-taker computing system 510 includes various hardware 516 to provide client-side emergency data processing, according to an embodiment. Hardware 516 may include, but is not limited to, central processing unit (CPU) 518, graphical processing unit (GPU) 520, a display 522, and memory 524. Memory 524 is representative of non-volatile memory but may include volatile memory, according to an embodiment. Memory 524 includes instructions or data representing application calls 526, data 234, and/or ECC data 210. Memory 524 may also include local application 528 (e.g., a native messaging host), a local LLM 226, and an OS LLM 224 provided by or managed by OS 534, according to an embodiment. Application 528 is an example implementation of applications 218, 306, and/or 406.

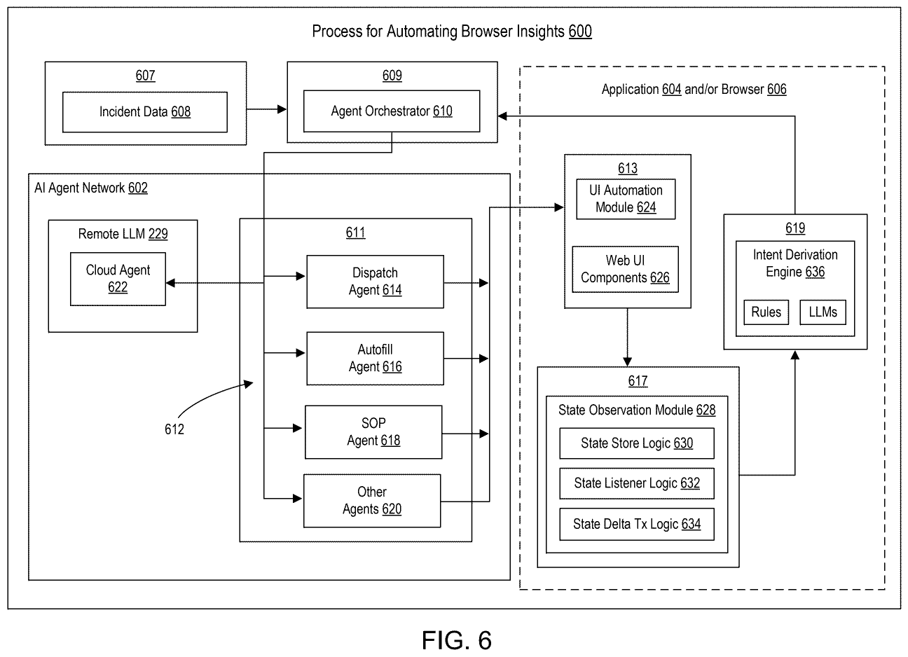

FIG. 6 illustrates a flow diagram 600 of client-side processing with an AI agent network, in accordance with aspects of the disclosure. Process 600 includes a number of operations that illustrate an interplay between AI agent network 602, application 604, browser 606, and/or various software/components to provide client-side emergency data processing, in accordance with aspects of the disclosure.

At operation 607, incident data 608 is received by a call-taker system from, for example, an ERDS and/or a public telephone network, according to an embodiment.

At operation 609, an agent orchestrator 610 provides the incident data to one or more LLMs 612 to perform client-side emergency data processing and/or to determine insights (e.g., suggestions, browser-based actions, and/or user notifications) based on the content of the incident data.

At operation 611 the one or more LLMs 612 operate as AI micro-agents to perform various specific or specialized tasks, according to an embodiment. LLMs 612 may include a dispatch agent 614, an autofill agent 616, a standard operation procedures (SOP) agent 618, and one or more other agents 620. Dispatch agent 614 a be configured to provide recommend dispatch protocols. Dispatch agent 614 is operable to recommend actions to dispatch such as an AED, an air ambulance, field responders, etc. Dispatch can also occur via a command-like interface with broad or fuzzy search capabilities. User searches or prompts, such as “AED”, may be routed to dispatch agent 614, which may recommend a particular AED to dispatch near a selected incident or which may be automatically dispatched by the agent. Autofill agent 616 generate content for auto filling UI fields and/or UI forms (e.g., of a dispatch protocol). Autofill agent 616 may use audio data from a 911 call and/or transcripts from the 911 call to suggest and/or generate autofill content, for example. Autofill agent 616 may also be operable to validate and complete address, telephone numbers, and/or coordinates. SOP agent 618 may be configured to recall standardized procedures based on previous decisions made for similar or associated incident data (e.g., 911 call content). Other agents 620 may include, for example, a summary agent that generates incident narrative or a summary of a group of events all together. LLMs 612 may be trained prior to being made available for download by the call-taker computing system. Although slower, agent orchestrator 610 may occasionally also request analysis and/or services from cloud agent 622.

At operation 613, UI automation module 624 receives the output from LLMs 612 and performs one or more updates or manipulations of web UI components 626. The updates or manipulation may include displaying suggestions (e.g., a unit recommendation, an SOP recommendation), perform UI actions (e.g., autofill UI components, dispatch an air ambulance, etc.), and/or display notifications (e.g., the dispatched field responders are 8 minutes from incident location), for example.

At operation 617, state observation module 628 may use state store logic 630, state listener logic 632, and state delta transmitter logic 634 to listen or monitor the new state of web UI components 626, store the state of web UI components 626, and determine/provide the change/delta of the state of web UI components 626, for example.

At operation 619, intent derivation engine 636 receives changes in state of web UI components 626 and applies rules and/or LLMs to the data to determine one or more actions. In one embodiment, operation 619 returns to operation 609, for example.

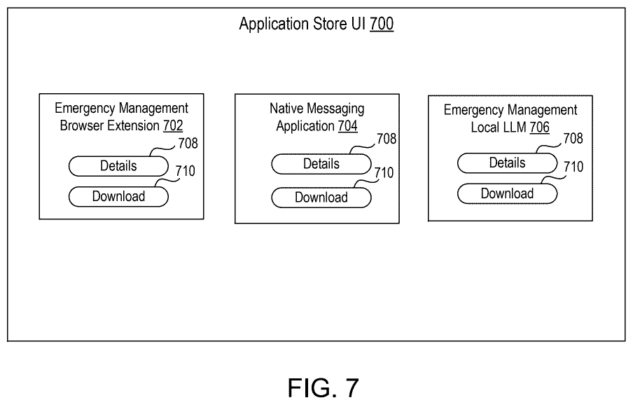

FIG. 7 illustrates a diagram of an application store UI 700, in accordance with aspects of the disclosure. Application store UI 700 is representative of online stores provided by browser providers (e.g., Chrome, Bing, Firefox, etc.) and/or operating system companies (e.g., Microsoft) to facilitate secure transfer and distribution of software assets. Application store UI 700 includes emergency management browser extension 702, messaging host application 704, and/or emergency management LLM 706, according to an embodiment. Each asset may include a details button 708 that enables display of an asset description and includes a download button 710 that enables download of a particular asset to a local client to support client-side emergency data processing, according to embodiments of the disclosure.

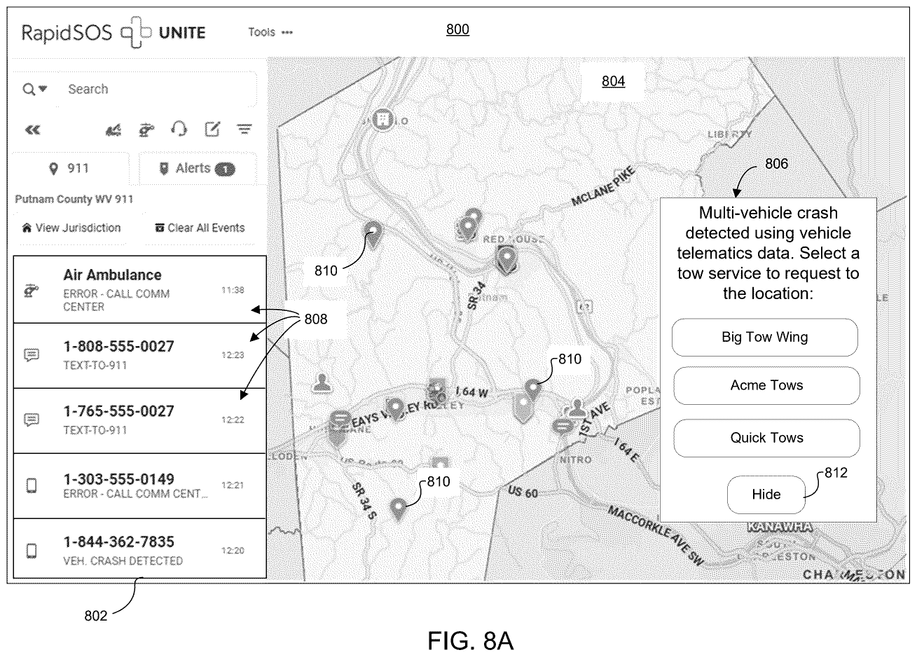

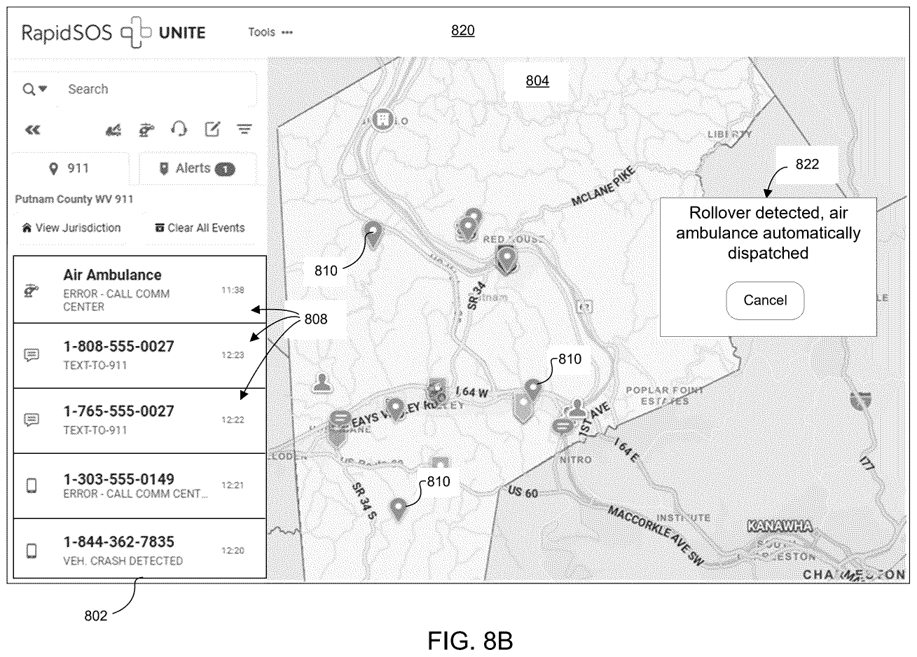

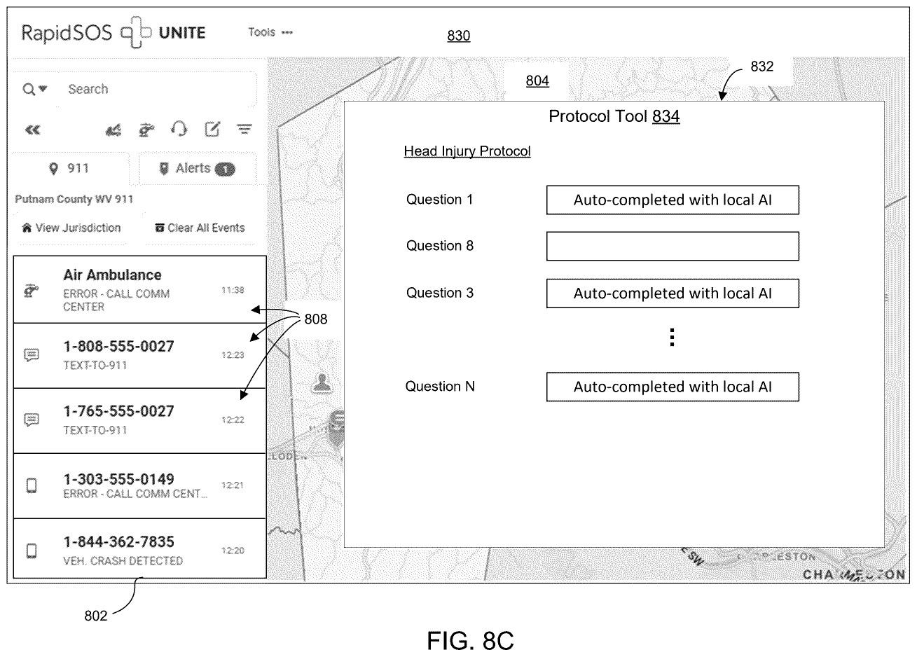

FIGS. 8A, 8B, and 8C illustrate various example diagrams of emergency response insights being displayed by an emergency management UI on ECC (or operations center) computing system, based on client-side emergency data processing, in accordance with various aspects of the disclosure. Emergency management UI 800 is an example implementation of a UI that may be displayed for one or more of an ECC emergency management application, an OC emergency management application, and/or a first responder emergency management application.

FIG. 8A illustrates a diagram of an emergency management UI 800, according to an embodiment. Emergency management UI 800 includes an incident queue 802, a map 804, and a suggestion 806 as an example of an AI generated emergency response insight, according to an embodiment. Incident queue 802 may display a number of incidents 808 that are displayed in incident queue 802, in response to receipt of an indication of an initiated emergency communication (e.g., a 911 call or a text to 911) by ERDS 102 (shown in FIGS. 1A and 1B). The indication of the initiated emergency communication may include caller information, which includes, but is not limited to, a telephone number, a location, a timestamp, and/or a personal identifier (e.g., a name) of a person registered with or associated with a user device 105 (e.g., a cell/smart phone). Map 804 is configured to display one or more pins 810 that represent a location of an initiated emergency communication. Each of pins 810 may be associated with a corresponding one of the incidents 808 displayed in incident queue 802.

Suggestion 806 is an illustrative example of an emergency response insight that is based on client-side emergency data processing, in accordance with aspects of the disclosure. Suggestion 806 may be based on one or more of telematics data, a text to 911, a 911 call, traffic data, weather data, and/or traffic camera footage received and processed by a native messaging host (e.g., a local application) and/or one or more local LLMs, for example. Suggestion 806 includes a notification of a multi-vehicle crash and a display of towing companies that may be requested by the selection of a UI element (e.g., a button). A button 812 may also be provided to enable a call-taker to hide suggestion 806.

FIG. 8B illustrates a diagram of an emergency management UI 820, according to an embodiment. Emergency management UI 820 includes an action 822 as an example of an AI generated emergency response insight, according to an embodiment. Action 822 may be displayed after, for example, an air ambulance was automatically requested/dispatched based on client-side emergency data processing. The emergency data may include incident characteristics such as a vehicle's velocity changed from 80 mph to 0 mph in 5 seconds with 4 roll-overs detected from vehicular telematics data.

FIG. 8C illustrates a diagram of an emergency management UI 830, according to an embodiment. Emergency management UI 830 includes a display of an action 832 as an example of an AI generated emergency response insight, according to an embodiment. Action 832 may be displayed after, for example, a 911 call was received and call audio or call transcripts are provided to a client-side emergency data processing system, for example. Action 832 may include autofill or auto-population of answers to pre-determined questions in a protocol tool 834 that is integrated into an emergency management application. Action 832 may include auto-selecting a head injury protocol for display in protocol tool 834, based on the content of the 911 call, for example. One or more micro-agents (e.g., autofill agent) may be used to determine the intent and/or select the protocol and/or actions to perform, according to an embodiment.

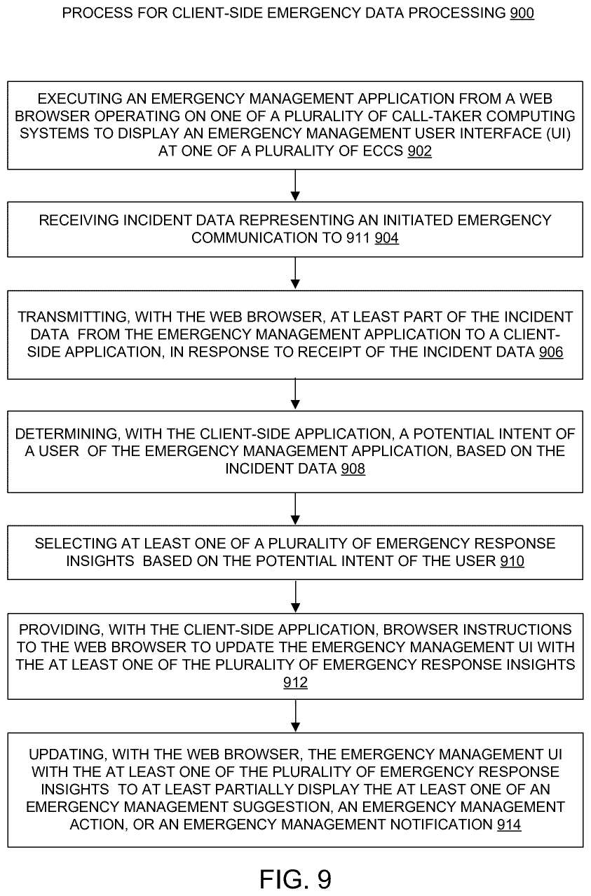

FIG. 9 illustrates a flow diagram of a process 900 for providing client-side emergency data processing, in accordance with aspects of the disclosure. Process 900 may be implemented by one or more aspects of disclosed emergency response systems and/or emergency response data systems. Process 900 includes a number of operations; it is to be understood that one or more of the operations may be performed out of the described order and/or in parallel with other operations.

At operation 902, process 900 includes executing an emergency management application from a web browser operating on one of a plurality of call-taker computing systems to display an emergency management user interface (UI) at one of a plurality of ECCs, according to an embodiment.

At operation 904, process 900 includes receiving incident data representing an initiated emergency communication to 911, according to an embodiment.

At operation 906, process 900 includes transmitting, with the web browser, at least part of the incident data from the emergency management application to a client-side application, in response to receipt of the incident data, according to an embodiment.

At operation 908, process 900 includes determining, with the client-side application, a potential intent of a user of the emergency management application, based on the incident data, according to an embodiment.

At operation 910, process 900 includes selecting at least one of a plurality of emergency response insights based on the potential intent of the user, according to an embodiment. The emergency response insights include an emergency management suggestion, an emergency management action, and/or an emergency management notification, according to an embodiment.

At operation 912, process 900 includes providing, with the client-side application, browser instructions to the web browser to update the emergency management UI with the at least one of the plurality of emergency response insights, according to an embodiment.

At operation 914, process 900 includes updating, with the web browser, the emergency management UI with the at least one of the plurality of emergency response insights to at least partially display the at least one of an emergency management suggestion, an emergency management action, or an emergency management notification, according to an embodiment.

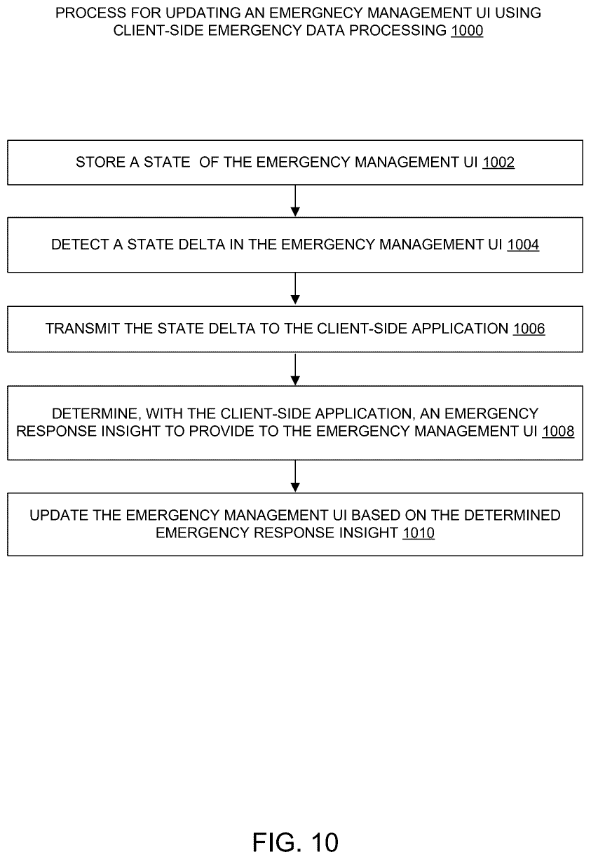

FIG. 10 illustrates a flow diagram of a process 1000 for providing client-side emergency data processing, in accordance with aspects of the disclosure. Process 1000 may be implemented by one or more aspects of disclosed emergency response systems or emergency response data systems. Process 1000 includes a number of operations; it is to be understood that one or more of the operations may be performed out of the described order and/or in parallel with other operations.

At operation 1002, process 1000 includes storing a state of the emergency management UI, according to an embodiment. The state of the emergency management UI may be defined by one or more variables used to populate UI elements with the emergency management UI, for example.

At operation 1004, process 1000 includes detecting a state delta in the emergency management UI, according to an embodiment.

At operation 1006, process 1000 includes transmitting the state delta to the client-side application, wherein the state delta includes characteristics of the incident data, according to an embodiment.

At operation 1008, process 1000 includes determining, with the client-side application, an emergency response insight to provide to the emergency management UI, according to an embodiment.

At operation 1010, process 1000 includes updating the emergency management UI based on the determined emergency response insight, according to an embodiment.

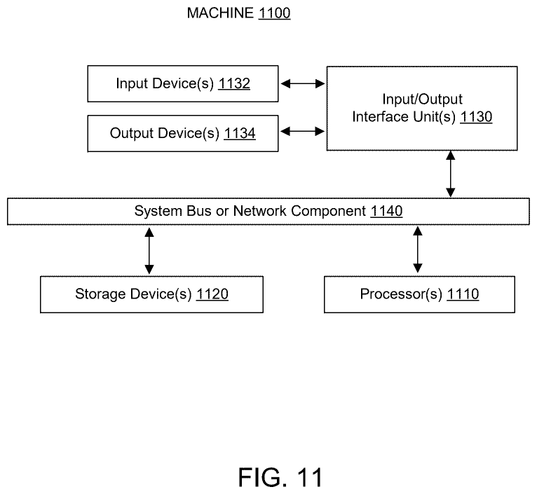

FIG. 11 is a high-level block diagram of a machine 1100 that may be used to implement one or more of the operations, devices, and/or systems disclosed herein. Machine 1100 includes one or more processors 1110, one or more input/output interface units 1130, one or more storage devices 1120, and one or more system buses and/or network components 1140 for facilitating the communication of information among the coupled elements. One or more input devices 1132 and one or more output devices 1134 may be communicatively coupled to the one or more input/output interfaces 1130.

The one or more processors 1110 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to affect one or more aspects of the present disclosure. At least a portion of the machine executable instructions may be stored (temporarily or more permanently) on the one or more storage devices 1120 (e.g., non-transitory computer-readable medium) and/or may be received from an external source via one or more input interface unit 1130.

In one embodiment, machine 1100 may be one or more conventional personal computers, servers, distributed computing systems, augmented reality devices, virtual reality devices, wearable systems, and/or computing devices. The processors 1110 may be one or more microprocessors. The bus 1140 may include a system bus. The storage devices 1120 may include system memory, such as read only memory (ROM) and/or random access memory (RAM). The storage devices 1120 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 1132, such as a keyboard and pointing device (e.g., a mouse) for example. Other input devices such as a microphone, a joystick, an image sensor, a game pad, a satellite dish, a scanner, or the like, may also (or alternatively) be included. These and other input devices are often connected to the processing unit(s) 1110 through an appropriate interface 1130 coupled to the system bus 1140. The output devices 1134 may include a monitor or other type of display device, which may also be connected to the system bus 1140 via an appropriate interface.

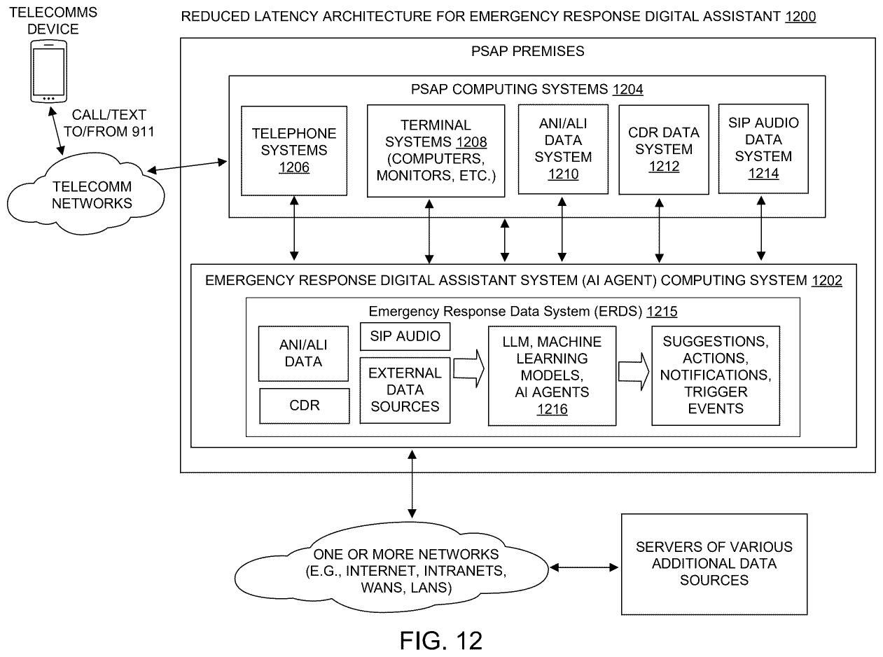

FIG. 12 illustrates an example diagram of a reduced latency architecture 1200 for an emergency response digital assistant, in accordance with embodiments of the disclosure. A computing system 1202 (e.g., a personal computer, a server, etc.) may be located on the premises (“on-prem”) of a PSAP. The computing system may be located in a server room and may be communicatively coupled to one or more PSAP computing systems 1204. The PSAP computing systems 1204 may include telephone systems 1206, terminal systems 1208 (e.g., computers, monitors, etc.), ANI/ALI data systems 1210 (e.g., servers, switches, etc.), CDR data systems 1212 (e.g., servers, switches, etc.), and/or SIP audio data systems 1214 (e.g., servers, switches, etc.). The computing system 1202 may be used to implement an emergency response digital assistant system 1215 (e.g., an emergency response AI agent) that receives and/or retrieves emergency data while implemented on the premises “on-prem” of a PSAP, processes the data using one or more LLMs, machine learning models, AI agents 1216, and provides one or more suggestions, actions, notifications, and/or trigger events. Example components and/or modules of the emergency response digital assistant system 1215 are illustrated throughout the present disclosure (e.g., see, FIG. 1B). Examples of various additional data sources (e.g., data source 104) are illustrated in, for example, FIG. 1B. By receiving, processing, and generating AI content (e.g., from SIP audio, ANI/ALI data, CDR data, and/or external data sources) on-prem to the PSAP, near real-time AI agent operations (e.g., suggestions, action, notifications, event triggers, etc.) may be provided with less reliance on external networks (e.g., Internet connections) and with less latency (e.g., by transmitting data to and receiving data from remote servers/services). Advantageously, the architecture of reduced latency architecture 1200 for an emergency response digital assistant may improve data security and reduce risks (e.g., latency) associated with remotely processing data. The LLMs, machine learning models, AI agents 1216 may be trained off-prem and/or periodically updated from an ERDS server, for example.

While this disclosure contains many specific implementation details, these should not be construed as limitations on the scope of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

References to “or” may be construed as inclusive so that any terms described using “or” may indicate any of a single, more than one, and all of the described terms. The labels “first,” “second,” “third,” and so forth are not necessarily meant to indicate an ordering and are generally used merely to distinguish between like or similar items or elements.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded with the widest scope consistent with this disclosure, the principles and the novel features disclosed herein.

The term “logic” and/or “processing logic” and/or “data processing hardware” in this disclosure may include one or more processors, microprocessors, multi-core processors, application-specific integrated circuits (ASIC), and/or field programmable gate arrays (FPGAs) to execute operations disclosed herein. In some embodiments, memory may be integrated into the logic to store instructions to execute operations and/or store data. Logic may also include analog or digital circuitry to perform the operations in accordance with embodiments of the disclosure. One or more aspects of the data processing hardware and/or processing logic and/or logic may be distributed between multiple computing systems and/or servers.

A “memory” or “memories” described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

A computing device or system may include a desktop computer, a laptop computer, a tablet, a phablet, a smartphone, a feature phone, a server computer, or otherwise. A server computing system may be located remotely in a data center, may be stored locally, and/or may have components (e.g., processors, memory, network interfaces, etc.) that are distributed across one or more locations.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application-specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

1. A computer-implemented method of client-side emergency data processing, comprising:
executing an emergency management application from a web browser operating on one of a plurality of call-taker computing systems to display an emergency management user interface (UI) at one of a plurality of ECCs;
receiving incident data representing an initiated emergency communication to 911;
transmitting, with the web browser, at least part of the incident data from the emergency management application to a client-side application, in response to receipt of the incident data;
determining, with the client-side application, a potential intent of a user of the emergency management application, based on the incident data;
selecting at least one of a plurality of emergency response insights based on the potential intent of the user, wherein the emergency response insights include at least one of an emergency management suggestion, an emergency management action, or an emergency management notification;
providing, with the client-side application, browser instructions to the web browser to update the emergency management UI with the at least one of the plurality of emergency response insights in response to detecting a state delta in the emergency management UI, wherein the state delta includes characteristics of the incident data; and
updating, with the web browser, the emergency management UI with the at least one of the plurality of emergency response insights to at least partially display the at least one of an emergency management suggestion, an emergency management action, or an emergency management notification.

2. The computer-implemented method of claim 1, wherein transmitting the at least part of the incident data with the web browser includes transmitting the at least part of the incident data with a browser extension having permissions to communicate with the client-side application.

3. The computer-implemented method of claim 2, wherein the browser extension includes nativeMessaging permissions to enable stdin and stdout communication with the client-side application.

4. The computer-implemented method of claim 1, wherein determining the potential intent of the user with the client-side application, further includes:
storing, by the one of the plurality of call-taker computing systems, one or more local large language models (LLMs);
sending, by the client-side application, the at least part of the incident data to the one or more LLMs;
prompting the one or more LLMs to determine the potential intent of the user; and
receiving, by the client-side application, the potential intent of the user.

5. The computer-implemented method of claim 1, further comprising:
storing, by the one of the plurality of call-taker computing systems, one or more local large language models (LLMs); and
prompting, with the client-side application, the one or more LLMs to at least partially define the browser instructions.

6. The computer-implemented method of claim 5, wherein the browser instructions include autofill data for auto-populating at least part of the emergency management UI.

7. The computer-implemented method of claim 6, further comprising: receiving audio data or transcripts of the initiated emergency communication to 911; and determining the autofill data from the audio data or the transcripts.

8. The computer-implemented method of claim 5, wherein the browser instructions include at least one of: display a portion of a standard operating procedure (SOP) in the emergency management UI; display a recommendation to dispatch a particular type of field responder to a particular location; or display a summary of a group of events related to the initiated emergency communication.

9. The computer-implemented method of claim 1, wherein the incident data includes at least one of: ANI (automatic number identification) data, ALI (automatic location identification) data; CDR (call detail record) data, or SIP (session initiation protocol) data.

10. The computer-implemented method of claim 1, further comprising:
storing a state of the emergency management UI;
detecting the state delta in the emergency management UI;
transmitting the state delta to the client-side application, wherein the state delta includes characteristics of the incident data; and
determining, with the client-side application, an emergency response insight to provide to the emergency management UI.

11. The computer-implemented method of claim 10, wherein determining the emergency response insight includes:
providing instructions to one or more artificial intelligence (AI) agents to determine the potential intent of the user; and
providing instructions to the one or more AI agents to generate content for the emergency response insight, based on the potential intent of the user,
wherein at least one or more LLMs includes a local LLM.

12. A client-side emergency data processing system, comprising:
memory storing instructions; and
one or more processors coupled to the memory and operable to execute the instructions to perform operations, the operations comprising:
execute an emergency management application from a web browser operating on one of a plurality of call-taker computing systems to display an emergency management user interface (UI) at one of a plurality of ECCs;
receive incident data representing an initiated emergency communication to 911;
transmit, with the web browser, at least part of the incident data from the emergency management application to a client-side application, in response to receipt of the incident data, via a browser extension having nativeMessaging permissions to enable stdin and stdout communication with the client-side application;
determine, with the client-side application, a potential intent of a user of the emergency management application, based on the incident data;
select at least one of a plurality of emergency response insights based on the potential intent of the user, wherein the emergency response insights include at least one of an emergency management suggestion, an emergency management action, or an emergency management notification;
provide, with the client-side application, browser instructions to the web browser to update the emergency management UI with the at least one of the plurality of emergency response insights; and
update, with the web browser, the emergency management UI with the at least one of the plurality of emergency response insights to at least partially display the at least one of an emergency management suggestion, an emergency management action, or an emergency management notification.

13. (canceled)

14. (canceled)

15. The client-side emergency data processing system of claim 12, wherein the operations to determine the potential intent of the user with the client-side application, further include:
store, by the one of the plurality of call-taker computing systems, one or more local large language models (LLMs);
send, by the client-side application, the at least part of the incident data to the one or more LLMs;
prompt the one or more LLMs to determine the potential intent of the user; and
receive, by the client-side application, the potential intent of the user.

16. The client-side emergency data processing system of claim 12, wherein the operations further comprise:
store, by the one of the plurality of call-taker computing systems, one or more local large language models (LLMs); and
prompt, with the client-side application, the one or more LLMs to at least partially define the browser instructions.

17. The client-side emergency data processing system of claim 16, wherein the browser instructions include autofill data for auto-populating at least part of the emergency management UI.

18. The client-side emergency data processing system of claim 17, wherein the operations further comprise:
receive audio data or transcripts of the initiated emergency communication to 911; and determine the autofill data from the audio data or the transcripts.

19. The client-side emergency data processing system of claim 16, wherein the browser instructions include at least one of: display a portion of a standard operating procedure (SOP) in the emergency management UI; display a recommendation to dispatch a particular type of field responder to a particular location; or display a summary of a group of events related to the initiated emergency communication.

20. The client-side emergency data processing system of claim 12, wherein the incident data includes at least one of: ANI (automatic number identification) data, ALI (automatic location identification) data; CDR (call detail record) data, or SIP (session initiation protocol) data.

21. The client-side emergency data processing system of claim 12, wherein the operations further comprise:
store a state of the emergency management UI;
detect a state delta in the emergency management UI;
transmit the state delta to the client-side application, wherein the state delta includes characteristics of the incident data; and
determine, with the client-side application, an emergency response insight to provide to the emergency management UI.

22. The client-side emergency data processing system of claim 21, wherein the operations to determine the emergency response insight includes:
provide instructions to one or more artificial intelligence (AI) agents to determine the potential intent of the user; and
provide instructions to the one or more AI agents to generate content for the emergency response insight, based on the potential intent of the user.
